(19) United States
(12) Patent Application Publication
(10) Pub. No.: US 2004/0128221 A1
(43) Pub. Date: Jul. 1, 2004

(54) Option valuation method and apparatus

(76) Inventor: Gurupdesh S. Pandher, Chicago, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/729,654

(22) Filed: Dec. 5, 2003

Related U.S. Application Data
(60) Provisional application No. 60/431,431, filed on Dec. 9, 2002.

(51) Int. Cl. G06F 17/60

(52) U.S. Cl. 705/36; 705/37

(57) ABSTRACT

Multiple potential termination events for a given option (such as a stock option) are identified. In a preferred approach, these termination events each effect a potentially different corresponding ex-severance value as regards valuation of the option itself. Such multiple severance risks are then reflected in a model that can be used to provide substantially risk-neutral valuation of the option.

### RELATED APPLICATION

I claim the benefit of Provisional Patent Application No. 60/431,431, entitled “Valuation of Executive Stock Options Under Multiple Severance Risks and Exercise Restrictions” and as filed on Dec. 9, 2002.

### TECHNICAL FIELD

This invention relates generally to valuation and more particularly to the valuation of options.

### BACKGROUND

Options of various kinds are known in the art, including but not limited to options that pertain to a right to obtain shares of a publicly traded (or privately held) stock, to mine or to drill, to purchase currencies, and so forth. In general, an option typically comprises a legal right that permits the holder to exercise a specified transaction by or before a given date upon a given set of terms and conditions notwithstanding changing circumstances that may otherwise arise and that may impact the then-present value of that future transaction.

In recent times, so-called executive stock options have been widely used to reward and/or to motivate employees at various hierarchical levels of a given enterprise. Because such options often represent a considerable, albeit future, value many regulatory agencies and/or accounting oversight entities encourage that such options be expensed. This, however, requires that an appropriate value first be assigned to the options. Guidelines of the Financial Accounting Standard Board (FASB) in the United States suggest using an option pricing model and many prior art practitioners interpret this to mean a model such as the well known Black-Scholes approach to measure the cost or value of stock options when granted by an enterprise.

Unfortunately, many options, such as employee stock options, are subject to several additional contingencies that are not in the Black-Scholes equation but can significantly alter the possible payoff. For example, severance with or without cause, including by death of the option holder, typically alters the payoff of an executive stock option. To illustrate, termination with cause or firm bankruptcy may entail forfeiture of the employee's options while termination without cause may simply advance the option's maturity date and require the departing employee to exercise the option immediately or not at all.

Because of these and possibly other factors, the Black-Scholes approach often significantly overestimates the value of a given allotment of options. In particular, ignoring such severance risks as those set forth above can overestimate such a value by more than thirty percent when the enterprise experiences an overall severance rate of only five percent.

### BRIEF DESCRIPTION OF THE DRAWINGS

The above needs are at least partially met through provision of the option valuation method and apparatus described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a graph depicting stock option valuation to maturity as per various valuation models;

FIG. 5 comprises a graph depicting stock option valuation to maturity as per various valuation models;

FIG. 6 comprises a graph depicting early exercise rates over time under option forfeiture upon severance; and

FIG. 7 comprises a graph depicting early exercise rates over time under option forfeiture upon severance.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, at least a first and second option termination event are identified. In a preferred embodiment, these at least two option termination events can each impact, in different ways, at least in part, a window of exerciseabilty and/or an option's termination-dependent value. These embodiments then provide an option pricing model as a function, at least in part, of a risk assessment for the first and second option termination event. Such an approach can be used with a variety of option situations including, but not limited to, stock options.

Pursuant to some embodiments, the option termination events correspond to employment termination events (such as, but not limited to, voluntary severance, severance for cause, death, and so forth).

There are various satisfactory approaches to facilitate provision of the option pricing model. Pursuant to one approach, the option pricing model can comprise providing an extension of a binomial model. Pursuant to another approach, the option pricing model can comprise providing a multi-termination partial differential equation-based pricing model.

These teachings are particularly apt for use with computational platforms of choice (including both central and distributed processing facilities).

So configured, a resultant option pricing method can be used to provide a valuation figure for a multiple termination option (that is, an option that can be terminated or otherwise fluctuate in value in various ways due to multiple causes such as termination in various ways (and/or at various times) in response to various triggering events or phenomena. This approach provides a more accurate view of the long term likely value of a given option event and thereby permits a more accurate reporting of same. This accuracy can be particularly helpful when applied in a stock option context as prior methods tend to significantly overvalue such options and thereby encourage a concurrent over-expensing of such options upon issuance.

Pursuant to one preferred embodiment, a stock option valuation model incorporates multiple severance risks with ex-severance values that depend on the employee's mode of exit from the enterprise (as distinct from many previous models that assume a single severance payoff for the option and thereby fail to price the cause-dependent severance structure of actual stock option grants). Also pursuant to at least one preferred embodiment, the severance event is modeled as a doubly stochastic Poisson probability process in a multi-severance binomial tree and a partial differential equation gain process. This specification permits the stock price and other state variables to effect the severance probabilities in a very flexible and stochastic fashion, allowing complex and rich information structures to be endogenously captured in the valuation. Such approaches yield a substantially risk-neutral valuation approach that finds near arbitrage-free prices that are independent of the option holder's personal risk and wealth attributes. This is an attractive feature of the model from the perspective of an enterprise attempting to find (and report) the cost of its employee stock option grants.

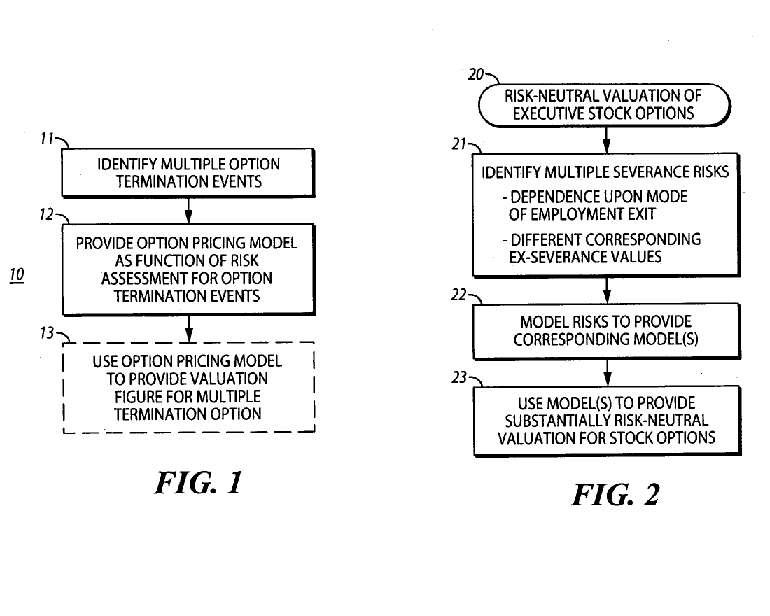

Referring now to the drawings, and in particular to FIG. 1, pursuant to these various embodiments, an overall process 10 for valuing options of various kinds can begin with identification 11 of multiple option termination events including at least a first and second option termination event. In a preferred approach, these termination events can each impact, in a different way, at least in part, a window of exerciseability as pertains to an option and/or a corresponding option's termination-dependent value. Options of various kinds can be accommodated; for purposes of this description the options will be portrayed as stock options but those skilled in the art will understand and appreciate that stock options are being used as a useful illustrative example and that these embodiments are not restricted to application with only stock options.

Also, and again for purposes of illustration, these option termination events will be portrayed as various employment termination events (such as, but not limited to, employment termination due to voluntary severance (including either or both of scheduled retirement and early severance), severance for cause, and involuntary severance due to death of the employee or firm bankruptcy). As already noted above, the employee's (or the employee's beneficiary's) right to exercise an option will often depend, at least in part, upon such termination events. For example, the ability to exercise one's stock options (including both vested and unvested stock options) can expire immediately upon being terminated for cause. On the other hand, an employee's right to exercise a vested option may continue for some period of time (such as three months or one year) following voluntary severance though unvested stock options (as of the date of severance) may be lost. In turn, of course, the literal value of the options for a given employee can vary dramatically when considering such termination events.

This process 10 then provides 12 an option pricing model as a function, at least in part, of a risk assessment for these various option termination events. As will be shown below in more detail, pursuant to one embodiment the option pricing model can comprise provision of an extension of a binomial model. Pursuant to another approach, a multi-termination partial differential equation-based pricing model can be used. Other approaches are likely suitable for application in this fashion as well.

The option pricing model can then be used 13 as desired to provide a valuation figure for a multiple termination option. To illustrate, a given enterprise can issue a stock option grant to a number of its employees. Using the option pricing model a value can be determined to fairly represent this grant. This value can then be used, for example, when declaring such an event as an expense for public or private accounting and/or reporting purposes.

To express a somewhat more detailed view of this approach in the specific area of stock options, and referring now to FIG. 2, a risk-neutral valuation of executive stock options 20 can include (or can be otherwise based upon) identification 21 of multiple severance risks (such as but not limited to voluntary severance, severance for cause, and severance due to death) wherein each of the severance risks is at least partially dependent upon an employee's mode of exit from corresponding employment and has a corresponding, different ex-severance value. One then models 22 these multiple severance risks to provide at least one corresponding model. For example, such modeling can include using a doubly stochastic Poisson probability process in at least one of a multi-severance binomial tree and in a multi-severance partial differential equation process. This model (or models) can then be used 23 to provide a substantially risk-neutral valuation for the executive stock options. In a preferred approach, this valuation comprises a substantially arbitrage-free value (and that is therefore substantially independent of, for example, the option holder's personal risk and/or a priori personal wealth).

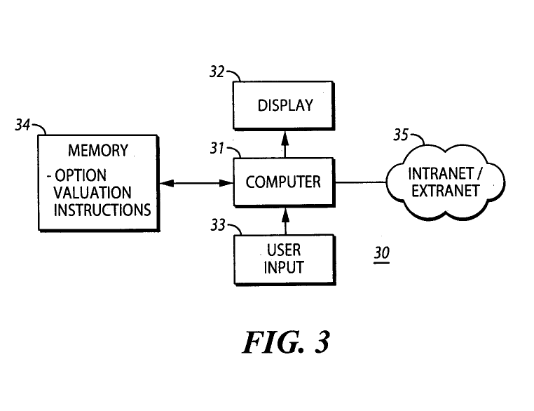

Such processes can be embodied in a variety of ways as will be well understood by those skilled in the art. Pursuant to a preferred approach, such a model will be partially or fully implemented as a set of computational instructions. With reference to FIG. 3, for example, a computer 31 having a display 32 and a user input 33 (such as a keyboard and cursor control mechanism) can further have (or couple to) a memory (or memories) 34 that include option valuation instructions that correspond, at least in part, to an option model that is a function, at least in part, of a risk assessment for multiple option termination events that can each impact in different ways, at least in part, a window of exerciseability as corresponds to an option. It will be understood by those skilled in the art that various architectural configurations are available to support such functionality and capability. For example, multiple computational platforms can be utilized to parse and/or otherwise distribute the overall valuation process over such multiple platforms. Such a distributed approach may be particularly appropriate when the computer 31 operably couples to a network 35 comprising, for example, an intranet or an extranet (such as the Internet) that provides ready access to other computational platforms. So configured, one or more computational platforms can serve as an option valuation server. Such servers can then receive relevant variable information for a requesting client, utilize an appropriate valuation model to determine a corresponding valuation, and return that calculated result to the requesting client or to such other recipient as may be designated.

More specific embodiments will now be described. First, a doubly stochastic Poisson probability representation for such severance events under such multiple causes will be described and then a standard binomial option pricing model will be extended to incorporate the multi-severance and cause-contingent ex-severance features of a typical executive stock option offering. A corresponding partial differential equation approach will also be identified.

Stock option awards typically have very long maturities, with ten years being a common maturity at issue. During this time, a stock option holder may exit the enterprise for a number of reasons: dismissal with cause, dismissal without cause, mortality, and so forth as has been noted above. For example, when termination occurs due to cause, the options may be forfeited completely, while in the case of dismissal without cause or mortality, the options can often be exercised immediately or within a restricted period of time (e.g. 3 months). Therefore, it can be seen that the stock option holder is exposed to substantial severance risk.

Let τ be the random future time at which severance occurs. Then, the severance event is conveniently represented by the survival indicator I_{[τ>u]} which takes on the value 1 prior to severance by time u and 0 thereafter. There are jε{1,2, . . . ,J} possible causes of severance and let τⱼ represent the future random time at which severance results from cause j. The future time of severance (from any cause) is given by τ=min{τ₁,τ₂, . . . ,τ_{J}}

The severance event is modeled as the first jump-time of a doubly stochastic Poisson process where severance hazard rate functions hₜⱼ≡hⱼ(sₜ,t): [symbol] ×[0, ∞]→[0, ∞) depend on the random stock price sₜ. The information set under which probabilities of future events are computed is represented by Gₜ=Hₜ [symbol] Dₜ which comprises information on both the stock price evolution (Hₜ) and the severance event (Dₜ). (More formally, in continuous time, {Dₜ,0≦t≦T} is the filtration Dₜ=σ(I_{[τ>u]},0≦u≦t) for the default process and the survival indicator I_{[τ>t]} is Dₜ-measurable. Similarly, {Hₜ,0≦t≦T} is the filtration Hₜ=σ(Xᵤ,0≦u≦t) for the stock process and Xₜ is Hₜ-measurable.) Given multiple severance risks, the probability of non-severance by time s computed at time t<s is given by

$$\begin{matrix}P r ( τ > s \vert {G}_{t} ) = {\prod }_{j = 1}^{J} P r ( {τ}_{j} > s \vert {G}_{t} ) \\ = E ( {\prod }_{j = 1}^{J} {I}_{[ {τ}_{j} > s ]} \vert {G}_{t} ) \\ = E ( E ( {\prod }_{j = 1}^{J} {I}_{[ {τ}_{j} > s ]} \vert {H}_{s} ⋁ {D}_{t} ) ) \vert {G}_{t} ) \\ = E ( {ⅇ}^{- {\int }_{t}^{s} ( {h}_{u1} + … + {h}_{uJ} ) ⅆ u} \vert {G}_{t} )\end{matrix} \qquad ( 1 )$$

where the law of iterated expectations is applied at the third equality using the fact that (Hₛ [symbol] Dₜ)⊂(Hₜ [symbol] Dₜ)=Gₜ. The conditioning argument allows the severance probability at future times to evolve with the state variables (e.g. the stock price) revealed at that time. The outer expectation then averages over the uncertainty in the future value of these state variables.

After introducing the relevant notation, risk-neutral arguments are applied to construct the multiple-severance binomial executive stock option model (MSB-ESO). Let s₀ be the initial stock price and let sₜε{(s₀u^{t}d⁰),(s₀u^{t-1},d¹), . . . ,(s₀u¹d^{t-1}),(s₀u⁰d^{t})}, t=1, . . . ,n, represent the stock prices in the binomial tree where n is the number of time steps up to maturity T (in years) of length Δ=T/n. At each node, the stock price either move up by the factor u=exp(σ\sqrt{Δ}) or down by the factor d=1/u where σ is the stock return volatility. Further, given the continuously compounded risk-free rate r and dividend yield Δ, the risk-neutral probabilities for the up and down movements of the stock price at each node are given by p=exp((r−Δ)Δ)−d/(u−d) and 1−p, respectively. In the context of the binomial model, the probability of survival over the next time-step under equation 1 becomes

$$\begin{matrix}P r ( τ > Δ ( t + 1 ) \vert \\ τ > Δ t , {s}_{t} )\end{matrix} = ( \begin{matrix}p {e}^{- ( {h}_{1} ( {s}_{t} u , Δ ( t + 1 ) ) + … + {h}_{J} ( {s}_{t} u , Δ ( t + 1 ) ) ) Δ} + \\ ( 1 - p ) {ⅇ}^{- ( {h}_{1} ( {s}_{t} d , Δ ( t + 1 ) ) + … + {h}_{J} ( {s}_{t} d , Δ ( t + 1 ) ) ) Δ}\end{matrix} ) \qquad ( 2 )$$

Let Wₜ(sₜ,I_{[τ>Δt]})≡Wₜ(sₜ,I_{[τ>Δt]};σ,r,K,T) represent the executive stock option call option value when exposed to multiple severance risks with exercise price K. Wₜ(sₜ,I_{[τ>Δt]}=1) represents the survived value of the executive stock option at time Δt and Wₜ(sₜ,I_{[τ>Δt]}=0,j) is the ex-severance value of the executive stock option when severance occurs due to cause j ε {1,2, . . . ,J} (assuming that the severance event occurs at the end of the period [Δ(t−1),Δt]). The corresponding hazard rate of severance at time Δt is hₜⱼ≡hⱼ(sₜ,Δt): [symbol] ×[0, ∞)→[0, ∞).

Executive stock option plans typically stipulate differing terms for the option under various modes of severance. Some examples of executive stock option ex-severance values are:

a) Severance with cause: loss of options

When the executive stock option holder is terminated due to cause the stock option award usually becomes null and void. The ex-severance payoff at the end of period [Δt,Δ(t+1)] may be written as

Wₜ₊₁(sₜ₊₁,I_{[τ>Δ(t+1)]}=0,j)=0 (3)

b) Severance without cause or mortality: reduction in ESO maturity

When the employee leaves voluntarily or is terminated without cause, the holder usually retains the vested options but may be required to exercise them within a specified period Tₛ (e.g. 3 months), thereby reducing the maturity of the executive stock option. Let V(sₜ₊₁,Tₛ) represent the value of an American call option with time to maturity Tₛ. The value of the stock option upon severance at the end of period [Δt,Δ(t+1)] is

Wₜ₊₁(sₜ₊₁,I_{[τ>Δ(t+1)]}=0,j)=V(sₜ₊₁,Tₛ) (4)

Alternatively, when the option holder must exercise immediately upon severance, then the continuation value of the stock option at each node of the binomial tree changes to

Wₜ₊₁(sₜ₊₁,I_{[τ>Δ(t+1)]}=0,j)=max(sₜ₊₁−K,0) (5)

Risk-neutral valuation of contingent claims is essentially based on the principle that if the price risk of the derivative security can be dynamically eliminated till expiration by holding positions in the underlying tradable asset, then to rule out arbitrage the hedged position must earn a return equal to the risk-free rate r. Equivalently, the derivative's arbitrage-free value may be determined by taking an expectation of the contingent claim under a special risk-neutral probability measure. The applicant has determined that risk-neutral arguments can be successfully applied to the present setting because although the option holder cannot freely sell the stock or the executive stock option, the enterprise is free to hedge the option using its stock directly or through a financial intermediary.

Working backwards through the binomial tree, the executive stock option value at time t in state sₜ is given by

Wₜ(sₜ,I_{[τ>Δt]}=1)=max([sₜ−K]Wₜ^{c}(sₜ,I_{[τ>Δt]}=1)) (6)

where the continuation value Wₜ^{c}(sₜ,I_{[τ>Δt]}=1) of the stock option is given by

$$\begin{matrix}{W}_{t}^{c} ( {s}_{t} , {I}_{[ τ > Δ t ]} = 1 ) = E ( {ⅇ}^{- r Δ} {W}_{t + 1} ( {s}_{t + 1} , {I}_{[ τ > Δ ( t + 1 ) ]} ) \vert {G}_{Δ t} ) \\ = E ( {ⅇ}^{- r Δ} E ( {W}_{t + 1} ( {s}_{t + 1} , {I}_{[ τ > Δ ( t + 1 ) ]} ) \vert {H}_{Δ ( t + 1 )} ⋁ {D}_{Δ t} ) \vert {G}_{Δ t} ) \\ = {ⅇ}^{- r Δ} \{ \begin{matrix}p [ \begin{matrix}{ⅇ}^{- h ( {s}_{t} u , Δ ( t + 1 ) ) Δ} \\ {W}_{t + 1} ( {s}_{t} u , {I}_{[ τ > Δ ( t + 1 ) ]} = 1 ) + \\ ( 1 - {ⅇ}^{- h ( {s}_{t} u , Δ ( t + 1 ) ) Δ} \\ {W}_{t + 1} ( {s}_{t} u , {I}_{[ τ > Δ ( t + 1 ) ]} = 0 )\end{matrix} ] + \\ ( 1 - p ) [ \begin{matrix}{ⅇ}^{- h ( {s}_{t} d , Δ ( t + 1 ) ) Δ} \\ {W}_{t + 1} ( {s}_{t} d , {I}_{[ τ > Δ ( t + 1 ) ]} = 1 ) + \\ ( 1 - {ⅇ}^{- h ( {s}_{t} d , Δ ( t + 1 ) ) Δ} \\ {W}_{t + 1} ( {s}_{t} d , {I}_{[ τ > Δ ( t + 1 ) ]} = 0 )\end{matrix} ]\end{matrix} \} .\end{matrix} \qquad ( 7 )$$

The expectation in equation 7 is taken under the doubly stochastic Poisson probability process and the conditioning arguments of equations 1 and 2 are employed in the second and third equalities. The new quantity Wₜ₊₁(sₜ₊₁,I_{[τ>Δ(t+1)]}=0) represents the expected value of the executive stock option over the severance states and is given by

$$\begin{matrix}{W}_{t + 1} ( {s}_{t + 1} , {I}_{[ τ > Δ ( t + 1 ) ]} = 0 ) = {\sum }_{j = 1}^{J} {W}_{t + 1} ( {s}_{t + 1} , {I}_{[ τ > Δ ( t + 1 ) ]} = 0 , j ) \\ \frac{{h}_{Δ ( t + 1 ) , j}}{{h}_{Δ ( t + 1 )}}\end{matrix} \qquad ( 8 )$$

for sₜ₊₁ ε{sₜu,sₜd}. This follows from calculating the option's conditional expected value under severance at end of period [Δt,Δ(t+1)]. This is given by

$$\begin{matrix}{\sum }_{j = 1}^{J} {W}_{t + 1} ( {s}_{t + 1} , {I}_{[ τ > Δ ( t + 1 ) ]} = 0 , j ) Pr ( τ = {τ}_{j} \vert τ = Δ ( t + 1 ) ) where \\ P r ( τ = {τ}_{j} \vert τ = Δ ( t + 1 ) ) = \frac{P r ( τ > Δ ( t + 1 ) ) {h}_{Δ ( t + 1 ) , j}}{P r ( τ > Δ ( t + 1 ) ) {h}_{Δ ( t + 1 )}} = \frac{{h}_{Δ ( t + 1 ) , j}}{{h}_{Δ ( t + 1 )}} .\end{matrix}$$

A given enterprise's human resource department typically has historical employment turnover data to allow estimation of annual severance probabilities of its employees and these can be disaggregated by cause.

From the perspective of the enterprise, it may be argued that employee severance risk is relatively well diversified. An enterprise with many employees, constant turnover, and a ready pool of potential replacements has relatively low exposure to the severance jump risk arising from any single employee. Therefore, on an aggregate level, the enterprise's employee severance risk is not systematic and is relatively diversified. (This may also represent a reasonable and practical assumption on empirical grounds. For example, one prior art study of 58 Fortune 500 firms for over 21 years finds an average of 17 executive stock option grants per firm. This line of reasoning implies that from the company's perspective, one may treat the enterprise's empirical severance probabilities as risk-neutral severance probabilities for the purpose of valuing its stock option grants.)

The above arguments for the enterprise do not typically apply to the option-holder, of course, and a utility framework is useful for complete analysis. This approach, however, benefits from information and assumptions on unobservables (such as an employee's tendencies with respect to risk-aversion and their wealth endowment) that pose substantial problems in implementation. Here, one can assert that the risk-neutral MSB-ESO model offers an easy to compute upper bound (much lower than a Black-Scholes approach) on the value of a stock option grant to the employee.

An enterprise can readily estimate from its employment turnover data the annual probabilities qⱼ that an employee will involuntarily leave the enterprise from each cause j. These probabilities can be converted to annualized hazard rates of severance (e.g. for qⱼ=0.05, hⱼ=−1n(1−qⱼ)=0.051293) or, alternatively, more refined statistical techniques such as Cox proportional hazard modeling may be employed to estimate hazard functions in terms of covariates, including the stock price. For severance related to mortality, age-gender specific actuarial life tables published by the Society of Actuaries may be used to quantify this probability distribution. A preferred approach considers a pricing application under three causes of severance: with cause, without cause, and mortality (as discussed below in more detail).

When an employee exercises a stock option prior to expiration, some option plans prevent the option holder from selling the stock for a certain period (e.g. 12 months). This restriction imposes an additional risk as the stock price can change over the holding period. In the risk-neutral world, however, the held stock grows at the risk-free rate over the holding period and its present value is just the current value of the stock. Therefore, the holding restriction typically does not effect the executive stock option.

Instead of waiting one year to sell the stock, the option holder may alternatively exercise the option and register the stock in the name of a financial intermediary at a (1−λ)% discount (typical discounts fall in the 10%-30% range). The effects of the discount sale alternative on option valuation is incorporated by replacing equation 6 with

Wₜ(sₜ,I_{[τ>t]}=1)=max([λsₜ−K]Wₜ^{c}(sₜ,I_{[τ>t]}=1)). (9)

An alternative method of valuation is to solve a multi-severance risk adjusted partial differential equation representing the executive stock option.

In the context of executive stock options, variants of a single discontinuity risk partial differential equation have been considered by various prior art practitioners. Such work, however, considers only a single aggregate cause of severance and restricts the executive stock option to one ex-severance value. A preferred approach obtains a multi-severance executive stock option partial differential equation under the doubly stochastic Poisson probability specification for the severance event.

For purposes of this explanation, t represents continuous-time and Xₜ represents the corresponding stock price (as opposed to sₜ in the binomial model) and make the standard Black-Scholes assumption that it obeys the following diffusion process under the risk-neutral probability measure Q:

dXₜ=(r−q)Xₜdt+σXₜdBₜ^{Q} (10)

where r is the risk-free rate (drift under Q), q is the rate of dividend payout rate, σ is the return volatility and Bₜ^{Q} is standard Brownian motion. To avoid a dramatic change of notation from that presented above, we understand

Wₜ(Xₜ,I_{[τ>t]}=1)≡W(t,Xₜ,I_{[τ>t]}=1):[0, ∞)× [symbol] ×{0,1}→[0, ∞) to be twice differentiable with respect to the first two arguments.

Mathematically, the risk-neutral pricing condition is that the discounted value of the derivative claim must be a Martingale under the risk-neutral probability measure Q:

E^{Q}{d{Wₛ(Xₛ,I_{[τ>s]}=1)e^{-rs}}|Gₜ}=0, 0<t<s<T. (11)

The terms of d{Wₛ(Xₛ,I_{[τ>s]}=1)e^{-rs}} are obtained by applying the generalized form of Ito's formula and the expectation in equation 11 is made using the law of iterated expectations: E(·|Gₜ)=E(E(·|Hₛ [symbol] Dₜ))|Gₜ). In particular, this gives

$$\begin{matrix}d \{ {W}_{s} ( {X}_{s} , {I}_{[ τ > s ]} = 1 ) {ⅇ}^{- r s} \} = d {W}_{s} ( {X}_{s} , {I}_{[ τ > s ]} = 1 ) {ⅇ}^{- r s} - \\ r {W}_{s} ( {X}_{s} , {I}_{[ τ > s ]} = 1 ) {ⅇ}^{- r s} \\ = \{ \begin{matrix}\begin{matrix}\begin{matrix}\frac{\partial W}{\partial s} + \frac{1}{2} {σ}^{2} {X}^{2} \frac{{\partial }^{2} W}{\partial {x}^{2}} + \\ ( ( r - q ) X + σ Xd {B}_{s}^{Q} ) \frac{\partial W}{\partial X} +\end{matrix} \\ [ {W}_{s} ( {X}_{s} , {I}_{[ τ > s ]} = 0 , j ) -\end{matrix} \\ {W}_{s} ( {X}_{s} , {I}_{[ τ > s ]} = 1 ) ] - \\ r {W}_{s} ( {X}_{s} , {I}_{[ τ > s ]} = 1 )\end{matrix} \} {ⅇ}^{- r s}\end{matrix} \qquad ( 12 )$$

where ΔWₛ≡Wₛ(Xₛ,I_{[τ>s]}=0,j)−Wₛ(Xₛ,I_{[τ>s]}=1) is the jump in executive stock option value due to severance at the moment [s,s+ds] and the remaining terms represent the diffusive change. From the doubly stochastic Poisson representation of Pr(τ>s|Gₜ), t<s, given by equation 1, the instantaneous severance measure is

$$\begin{matrix}\frac{\partial P r ( τ < s \vert {G}_{t} )}{\partial s } = \frac{\partial [ 1 - P r ( τ > s \vert {G}_{t} ) ]}{\partial s } \\ E ( ( {h}_{s1} + … + {h}_{sJ} ) {ⅇ}^{- {\int }_{t}^{s} ( {h}_{u1} + … + {h}_{uJ} ) ⅆ u} \vert {G}_{t} ) .\end{matrix} \qquad ( 13 )$$

Similarly, the instantaneously severance measure due to cause j=1, . . . , J is given by

$$\frac{\partial P r ( τ < s , j \vert {G}_{t} )}{\partial s } = E ( {h}_{s j } {ⅇ}^{- {\int }_{t}^{s} ( {h}_{u1} + … + {h}_{uJ} ) ⅆ u} \vert {G}_{t} ) . \qquad ( 14 )$$

Taking the conditional expectation of equation 11 under the law of iterated expectations E(·|Gₜ)=E(E(·|Hₛ [symbol] Dₜ))|Gₜ) with t<s<T

(where (Hₛ [symbol] Dₜ)⊂(Hₜ [symbol] Dₜ)=Gₜ) yields

$$\begin{matrix}{E}^{Q} \{ d \{ {W}_{s} ( {X}_{s} , {I}_{[ τ > s ]} = 1 ) {ⅇ}^{- r s} \} \vert {G}_{t} \} \\ = {E}^{Q} ( ( \{ \begin{matrix}\begin{matrix}\begin{matrix}\frac{\partial W}{\partial s} + \frac{1}{2} {σ}^{2} {X}_{s}^{2} \frac{{\partial }^{2} W}{\partial {X}^{2}} + \\ ( ( r - q ) {X}_{s} + σ {X}_{s} d {B}_{s}^{Q} ) \frac{\partial W}{\partial X} +\end{matrix} \\ [ {W}_{s} ( {X}_{s} , {I}_{[ τ > s ]} = 0 , j ) -\end{matrix} \\ {W}_{s} ( {X}_{s} , {I}_{[ τ > s ]} = 1 ) ] - \\ r {W}_{s} ( {X}_{s} , {I}_{[ τ > s ]} = 1 )\end{matrix} \} {ⅇ}^{- r s} \vert {H}_{s} ⋁ {D}_{t} ) \vert {G}_{t} ) \\ = {E}^{Q} ( \{ \begin{matrix}\begin{matrix}\begin{matrix}\begin{matrix}\frac{\partial W}{\partial s} + \frac{1}{2} {σ}^{2} {X}_{s}^{2} \frac{{\partial }^{2} W}{\partial {X}^{2}} + \\ ( r - q ) {X}_{s} \frac{\partial W}{\partial X} - r {W}_{s} ( {X}_{s} , {I}_{[ τ > s ]} = 1 ) +\end{matrix} \\ σ {X}_{s} , \frac{\partial W}{\partial X} d {B}_{s}^{Q} +\end{matrix} \\ [ {\prod }_{j = 1}^{J} {h}_{s j} {W}_{s} ( {X}_{s} , {I}_{[ τ > s ]} = 0 , j ) -\end{matrix} \\ ( {h}_{s1} + … + {h}_{sJ} ) {W}_{s} ( {X}_{s} , {I}_{[ τ > s ]} = 1 ) ]\end{matrix} \} {ⅇ}^{- r s} {ⅇ}^{- {\int }_{t}^{s} ( {h}_{u1} + … + {h}_{uJ} ) ⅆ u} \vert {G}_{t} )\end{matrix}$$

where the conditional expectation of the jump component ΔWₛ is

$${E}^{Q} ( [ {\sum }_{j = 1}^{J} {h}_{s j} {W}_{s} ( {X}_{s} , {I}_{[ τ > s ]} = 0 , j ) - ( {h}_{s1} + … + {h}_{sJ} ) {W}_{s} ( {X}_{s} , {I}_{[ τ > s ]} = 1 ) ] {ⅇ}^{- {\int }_{t}^{s} ( {h}_{u1} + … + {h}_{uJ} ) ⅆ u} \vert {G}_{t} ) .$$

Next, applying the no-arbitrage Martingale condition of equation 11 gives the required restriction on the evolution of the executive stock option value process stated in equation 15 below.

The resulting multi-severance risk executive stock option partial differential equation is given by

$$\frac{\partial W}{\partial s} + \frac{1}{2} {σ}^{2} {X}^{2} \frac{{\partial }^{2} W}{\partial {X}^{2}} + ( r - q ) {X}_{s} \frac{\partial W}{\partial X} - {rW}_{s} ( {X}_{s} , {I}_{[ τ > s ]} = 1 ) + [ {\sum }_{j = 1}^{J} {h}_{sj} {W}_{s} ( {X}_{s} , {I}_{[ τ > s ]} = 0 , j ) - ( {h}_{s1} + … + {h}_{sJ} ) {W}_{s} ( {X}_{s} , {I}_{[ τ > s ]} = 1 ) ] = 0 \qquad ( 15 )$$

for 0≦s<T where W_{T}(X_{T},I_{[τ>T]}=1)=(X_{T}−K)⁺ is the stock option's terminal value, Wₛ(Xₛ,I_{[τ>s]}=0,j) is the executive stock option's ex-severance value when triggered by cause j=1, . . . ,J and hₜⱼ≡hⱼ(Xₜ,t): [symbol] ×[0, ∞]→[0, ∞) is the corresponding hazard rate function of severance.

The executive stock option may be valued by solving the multi-severance risk executive stock option partial differential equation of equation 12 using numerical methods (e.g. explicit finite differences, implicit finite differences, Crank-Nicholson). The early-exercise and discounted exercise features can be easily applied at each iteration in the finite difference procedure.

An illustrative implementation of the multi-severance binomial executive stock option (MSB-ESO) model as applied to value a stock option grant under three causes of potential severance will now be described. The numerical study also investigates the valuation bias from using alternative models (in particular Black-Scholes and exogenous adjustment to Black-Scholes) and the effect of volatility on the bias and early exercise.

In this example an executive stock option grant consists of 500,000 shares having a maturity of 10 years and a vesting period of 3 years. The initial market price of the stock is X₀=$50, the annualized return volatility is σ=50%, and the stock is non-dividend paying. This example considers three causes of job severance (J=3): with cause (j=1), without cause (j=2), and mortality (j=3). The employee's annual probabilities of severance is taken to be 2% for severance with cause (q₁=0.02) and 3% for severance without cause (q₂=0.03). With respect to mortality, the probabilities of mortality (q₃ₜ, t=1, . . . ,10) as reported in the actuarial life tables published by the Society of Actuaries for an insured male aged 50 are used: q₃=(0.00317, 0.00343, 0.00379, 0.00420, 0.00472, 0.00534, 0.00599, 0.00668, 0.00724, 0.00789). In this implementation, the annual probabilities are converted to the relevant severance hazard rate by cause.

The valuation of such an executive stock option is considered under the following models:

A) Black-Scholes call option value (no severance risk adjustment)

B) MSB-ESO model with the following cause-dependent severance payoffs

B-1) Loss of stock option plan upon severance for cause j=1

B-2) Immediate exercise upon severance for cause j=2

B-3) Three month option expiry upon severance for cause j=3

C) Severance probability adjusted Black-Scholes.

In addition, valuation is considered under both the 12-month stock holding restrictions as well as the 90% discount sale alternative. Scenario C refers to a simple approach of adjusting the Black-Scholes option value by the probability of non-severance Pr(τ>T|τ>t)=exp(−Σₜ₌₁ⁿhₜΔ) .

TABLE 1

| | | | | C |
|---|---|---|---|---|
| | Time to | A | | Black-Scholes |
| Type of Stock | Vesting/Shares/ | Black-Scholes | B | Probability |
| Holding Restriction | BS Bias | Valuation | MSB-ESO | Adjusted |
| No Restriction/ | 0 Yrs Vesting | 33.6021 | 26.2847 | 19.6135 |
| Stock Holding | 500,000 shrs | ($16,801,026) | ($13,142,349) | ($9,806,745) |
| | BS Bias | 28% | | −25% |
| | 3 Yrs Vesting | 33.6021 | 25.0560 | 19.6135 |
| | 500,000 shrs | ($16,801,026) | ($12,527,992) | ($9,806,745) |
| | BS Bias | 34% | | −22% |
| 90% Discount | 0 Yrs Vesting | 33.6021 | 25.3250 | 19.6135 |
| Sale | 500,000 shrs | ($16,801,026) | ($12,662,487) | ($9,806,745) |
| | BS Bias | 33% | | −23% |
| | 3 Yrs Vesting | 33.6021 | 24.1067 | 19.6135 |
| | 500,000 shrs | ($16,801,026) | ($12,053,342) | ($9,806,745) |
| | BS Bias | 39% | | −19% |

As reported in Table 1, valuation under severance risk is substantially lower than under the Black-Scholes (BS) model. Comparing columns A and B shows that BS overestimates the option value by between 28% to 39%, leading to significant over valuation of the stock option grant. Black-Scholes gives a valuation of $16,801,026 while the multi-severance binomial executive stock option model yields a value of $12,527,992 with a vesting period of 3 years (first row). Meanwhile, the probability adjusted BS method undervalues the option grants by 19 to 25%.

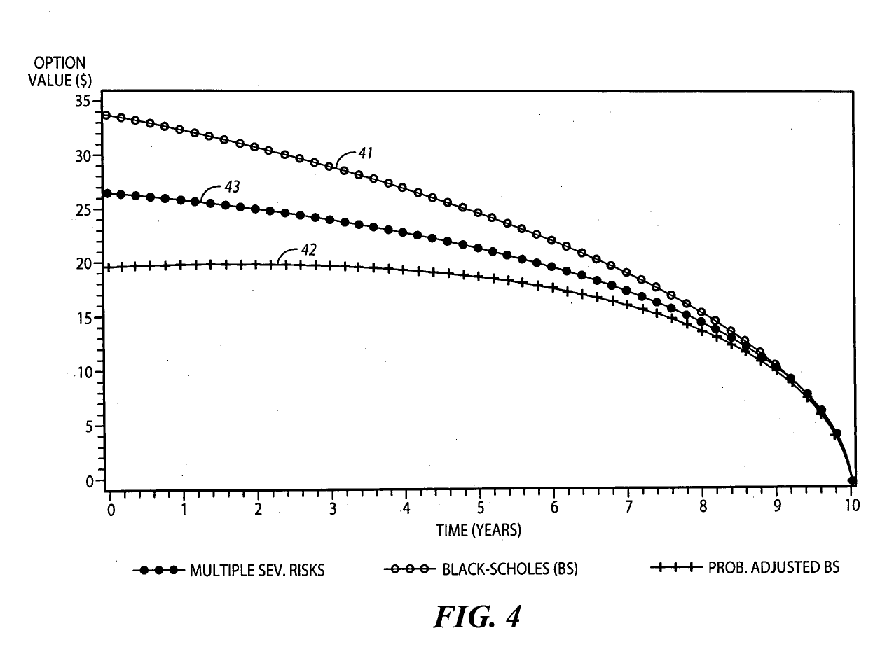

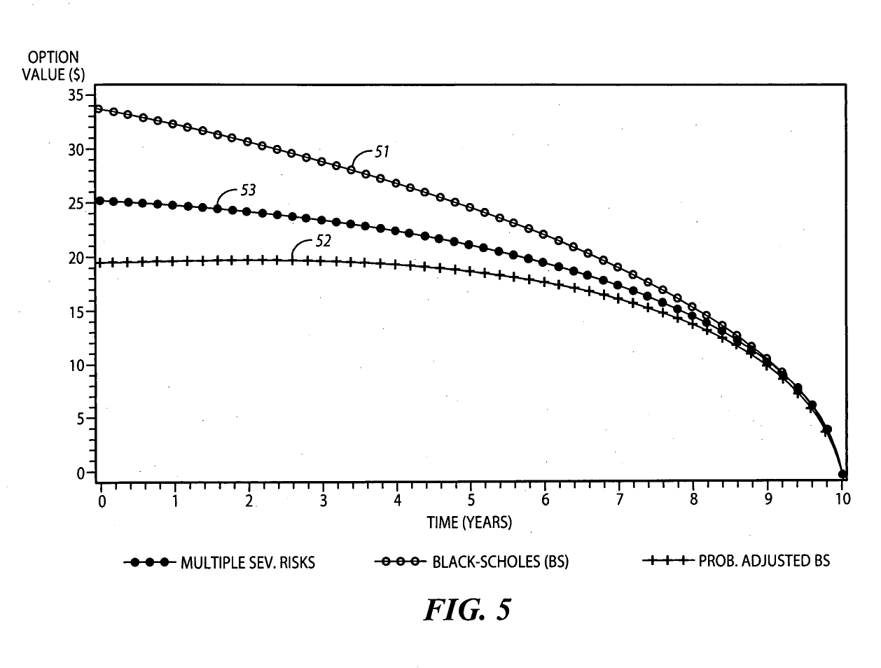

Plots of the resultant valuation figures are presented in FIGS. 4 and 5 (where the figures in FIG. 4 presume no restrictions with respect to an early exercise feature and the figures in FIG. 5 presume a 90% discount sale with respect to an early exercise feature). The present preferred approach yields the middle curve 43 and 53 depicted in FIGS. 4 and 5, respectively. It can be seen that ignoring severance risk, as done by ordinary Black-Scholes pricing, can lead to dramatic overvaluation of the executive stock option value (top curve 41 and 51 in FIGS. 4 and 5, respectively) while a simple adjustment to the Black-Scholes value by the probability of survival as corresponds to at least one prior art suggestion leads to significant undervaluation (bottom curve 42 and 52 in FIGS. 4 and 5, respectively). The latter adjustment ignores the additional value from early exercise under severance risk exposure as well as the severance-contingent payoffs of the stock option grant.

The effect of stock volatility and strike price on executive stock option valuation will be considered next. For purposes of this illustrative example the same parameter settings are maintained as in Table 1 but valuation is now performed under two levels of volatility (σ=20% and 50%) and three levels of exercise prices (0.8 X₀, X₀, 1.2 X₀). Numerical results for the case of vested options with no stock holding restriction (same as 12-month holding) are reported in Table 2.

TABLE 2

| | Strike | | | | C |
|---|---|---|---|---|---|
| | Moneyness | | A | | Black-Scholes |
| Stock | (m) | | Black-Scholes | B | Probability |
| Volatility σ | K = mX₀ | | Valuation | MSB-ESO | Adjusted |
| σ = 50% | .8 | Option Value | 35.7487 | 28.6995 | 20.8665 |
| | | BS Bias | 24.6% | | −27.3% |
| | | Early Ex. Rate | | 39.7% | |
| | 1 | Option Value | 33.6021 | 26.2847 | 19.6135 |
| | | BS Bias | 27.8% | | −25.4% |
| | | Early Ex. Rate | | 38.6% | |
| | 1.2 | Option Value | 31.8869 | 24.4089 | 18.6124 |
| | | BS Bias | 30.6% | | −23.7% |
| | | Early Ex. Rate | | 37.6% | |
| σ = 20% | .8 | Option Value | 27.0798 | 20.8436 | 15.8064 |
| | | BS Bias | 29.9% | | −24.2% |
| | | Early Ex. Rate | | 32.6% | |
| | 1 | Option Value | 22.5682 | 16.6001 | 13.1730 |
| | | BS Bias | 36.0% | | −20.6% |
| | | Early Ex. Rate | | 30.0% | |
| | 1.2 | Option Value | 18.7949 | 13.3260 | 10.9706 |
| | | BS Bias | 41.0% | | −17.7% |
| | | Early Ex. Rate | | 27.8% | |

Again, Black-Scholes (BS) valuation and the probability adjustment for severance lead to significant over and under valuation, respectively. The extent of the bias tends to depend on the volatility and moneyness of the option. An increase in volatility from σ=20% to σ=50% reduces the BS pricing bias from the range of 30% to 41% to 25% to 30%. On the other hand, the undervaluation bias in the probability adjusted Black-Scholes increases from 18% to 24% to 24% to 27% as volatility rises. Therefore, the use of Black-Scholes for option expensing would appear to likely lead to a larger overvaluation bias for lower volatility blue-chip stocks than, for example, the more volatile (at present) NASDAQ technology stocks. The Black-Scholes bias also appears to increase uniformly with the option's exercise price.

In addition, column B also reports the Early Exercise Rate for the MSB-ESO model. This is the fraction of the total states in the binomial tree where early exercise occurred. An increase in volatility raises the early exercise rate. As stock volatility increases from σ=20% to σ=50%, the early exercise rates increase from 28% to 33% to 38% to 40%. While volatility increases the continuation value of the option under severance, it also has the offsetting effect of raising the immediate payoff from early exercise. The empirical results suggest that the latter effect dominates, yielding a positive relationship between volatility and early-exercise. Further, early exercise rates fall as the exercise price rises.

The impact on executive stock option valuation of specific ex-severance option values independently (option loss, immediate exercise, and three month exercise) will now be considered. The same parametric settings are maintained as before, however, there is now only one source of severance (J=1) and the annual probability of severance is set at q=5% (severance hazard rate of h=0.051293). The stock options are valued under the following models:

A) Black-Scholes call option value (no severance risk adjustment)

B) MSB-ESO valuation with the following ex-severance payoffs:

B-1) Loss of stock option plan,

B-2) Immediate exercise

B-3) Three month option expiry

C) Severance probability adjusted Black-Scholes.

TABLE 3

| | | | | | | | C |
|---|---|---|---|---|---|---|---|
| | | | A | | | | Prob. |
| | | | Black- | B | | | Adjusted |
| | | | Scholes | MSB-ESO | | | Black- |
| | Strike | | A | | | B-3 | Scholes |
| | Moneyness | | BS | B-1 | B-2 | Three- | C |
| Stock | (m) | | Call | Option | Immediate | month | Prob. Adj. |
| Volatility σ | K = mX₀ | | Option | Loss | Exercise | Expiry | To A |
| σ = 50% | .8 | Option Value | 35.7487 | 26.3086 | 31.7063 | 31.7167 | 21.4041 |
| | | Early Ex. | | 40.3% | 0 | 0 | |
| | | Exogenous | | 35.9% | 12.7% | 12.7% | 67.0% |
| | 1 | Option Value | 33.6021 | 24.1902 | 28.9779 | 28.9895 | 20.1188 |
| | | Early Ex. | | 41.4% | 0 | 0 | |
| | | Exogenous | | 38.9% | 16.0% | 15.9% | 67.0% |
| | 1.2 | Option Value | 31.8869 | 22.5533 | 26.8613 | 26.8762 | 19.0919 |
| | | Early Ex. | | 40.3% | 0 | 0 | |
| | | Exogenous | | 41.4% | 18.7% | 18.6% | 67.0% |
| σ = 20% | .8 | Option Value | 27.0798 | 17.9606 | 23.8241 | 23.8268 | 16.2137 |
| | | Early Ex. | | 40.0% | 0 | 0 | |
| | | Exogenous | | 50.8% | 13.7% | 13.7% | 67.0% |
| | 1 | Option Value | 22.5682 | 14.4890 | 18.7638 | 18.7695 | 13.5124 |
| | | Early Ex. | | 37.0% | 0 | 0 | |
| | | Exogenous | | 55.8% | 20.3% | 20.2% | 67.0% |
| | 1.2 | Option Value | 18.7949 | 11.8290 | 14.9109 | 14.9120 | 11.2532 |
| | | Early Ex. | | 34.7% | 0 | 0 | |
| | | Exogenous | | 58.9% | 26.0% | 26.0% | 67.0% |

Table 3 shows that the largest impact on option valuation occurs when options are lost upon severance (B-1). In this case, the Black-Scholes overvaluation bias increases from 36% to 41% to 51% to 59% when volatility falls from σ=50% to σ=20%. In the case where options must be exercised within three months of severance (B-3), the bias in pricing drops to 12.7% to 18.7% for σ=50% and 13.7% to 26.0% for σ=20%, respectively.

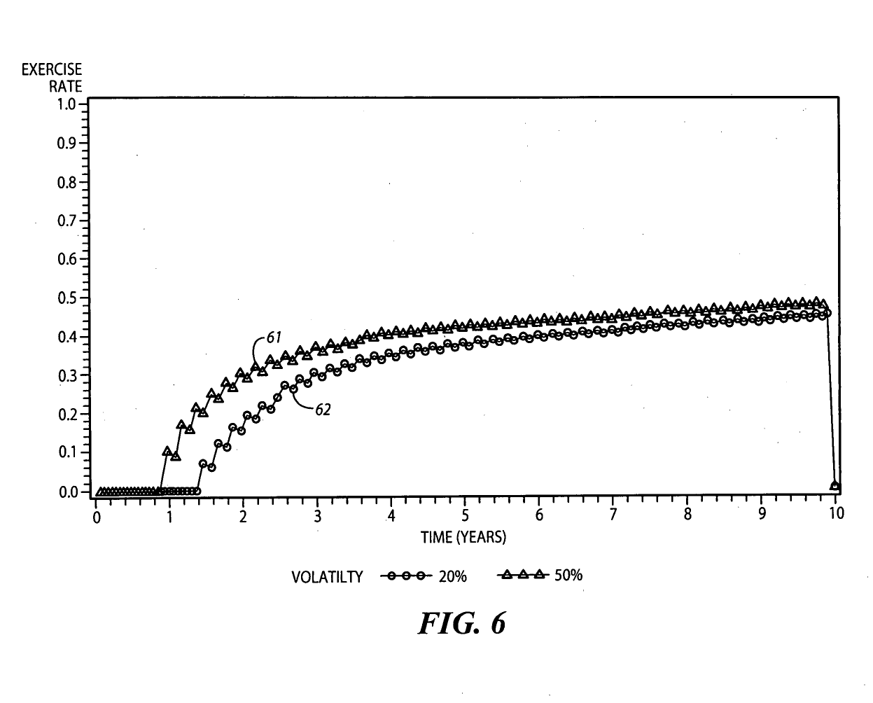

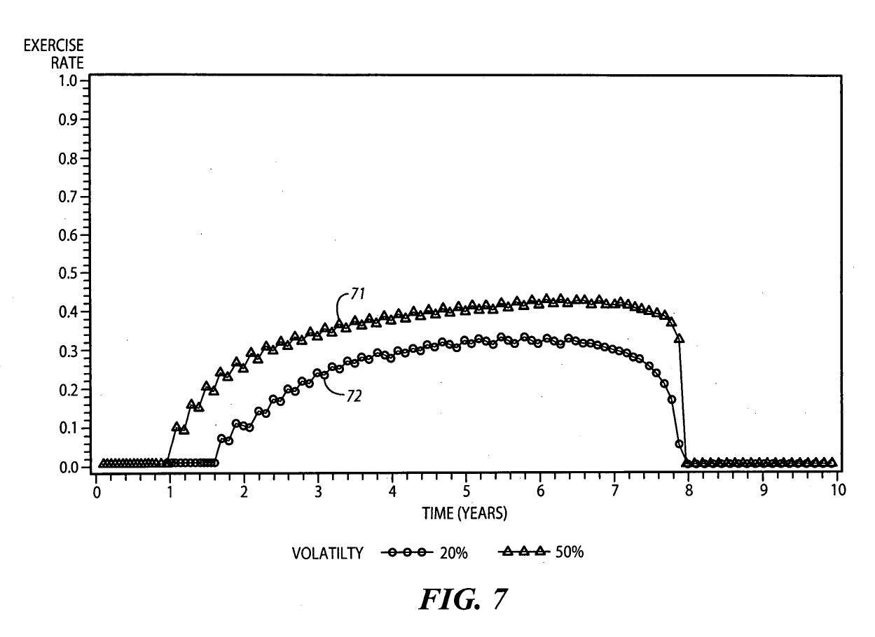

The Early Exercise Rates show that early exercise is optimal only when options are lost upon severance (B-1) while there is no early exercise for immediate exercise (B-2) and three month expiration (B-3). For scenario B-1, a detailed breakdown of early exercise rates at different times in the life of the stock option (strike at the money) are presented in FIGS. 6 and 7. FIG. 6 shows that under the no stock holding restriction (and 12-month stock holding), as the volatility drops from 50% (61) to 20% (62), the interval over which early exercise occurs shrinks from 0.9 to 10 years to 1.4 to 10 years. With reference to FIG. 7, and again comparing a volatility drop from 50% (71) to 20% (72), the same shrinkage in interval for the 90% discount sale feature is from 1 to 8 years to 1.6 to 8 years. Volatility is therefore seen to increase both the rates of early exercise as well as the span of the early exercise time zone.

These embodiments present a risk-neutral model for valuing options such as executive stock options that are exposed to risk (such as severance risk) from multiple sources (e.g. dismissal with cause, without cause, mortality, and so forth) with varying cause-contingent severance payoffs and option (or stock) holding restrictions. Such features of options do not conform with the assumptions of the Black-Scholes model. In the context of option expensing, the preferred model offers the further advantage that valuation does not depend on the risk aversion and endowment of the option holder. This is an attractive feature of the model for an enterprise attempting to find the total severance-adjusted value of options it has granted.

Valuation may be performed by implementing either the described multi-severance binomial executive stock option model or by numerically solving the corresponding multi-severance partial differential equation. Both representations accommodate the option's varying cause-contingent payoffs and the severance event is modeled using a flexible doubly stochastic Poisson process with stochastic hazard parameters. Such embodiments enable complex and rich information structures between state variables and the severance event to be incorporated during valuation. Therefore, the model also endogenously values the employee's early exercise decision as severance risk diminishes the executive stock option continuation value.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method for valuing options comprising:
identifying at least a first and second option termination event which first and second option termination event can each impact in different ways, at least in part, a window of exerciseability and an option's termination-dependent value;
providing an option pricing model as a function, at least in part, of a risk assessment for the first and second option termination event.

2. The method of claim 1 wherein the method for valuing options further comprises a method for valuing stock options.

3. The method of claim 2 wherein identifying at least a first and second option termination event which first and second option termination event can each impact in different ways, at least in part, a window of exerciseability and an option's termination-dependent value comprises identifying at least a first and second stock option termination event which first and second stock option termination event can each impact in different ways, at least in part, a window of exerciseability and an option's termination-dependent value.

4. The method of claim 1 wherein the first and second option termination events correspond to employment termination events.

5. The method of claim 4 wherein at least one of the employment termination events comprises at least one of:
voluntary severance;
severance for cause;
death;
corporate bankruptcy.

6. The method of claim 1 wherein providing an option pricing model further comprises providing an extension of a binomial model.

7. The method of claim 1 wherein providing an option pricing model further comprises providing a multi-termination partial differential equation-based pricing model.

8. The method of claim 1 and further comprising using the option pricing model to provide a valuation figure for a multiple termination option.

9. A method for facilitating risk-neutral valuation of executive stock options while taking into account multiple severance risks and exercise restrictions comprising:
identifying multiple severance risks wherein each of the severance risks:
is at least partially dependent upon an executive's mode of exit from corresponding employment; and
has a corresponding, different ex-severance value;
modeling the multiple severance risks to provide at least one corresponding model;
using the at least one corresponding model to provide a substantially risk-neutral valuation for the executive stock options.

10. The method of claim 9 wherein identifying multiple severance risks comprises identifying at least one of:
voluntary severance;
severance for cause;
death;
corporate bankruptcy.

11. The method of claim 9 wherein modeling the multiple severance risks to provide at least one corresponding model comprises using a doubly stochastic Poisson probability process.

12. The method of claim 11 wherein using a doubly stochastic Poisson probability process further comprises using a doubly stochastic Poisson probability process in at least one of a multi-severance binomial tree and in a multi-severance partial differential equation process.

13. The method of claim of claim 9 wherein using the at least one corresponding model to provide a substantially risk-neutral valuation for the executive stock options further comprises using the at least one corresponding model to provide a substantially risk-neutral valuation for the executive stock options wherein the substantially risk-neutral valuation comprises a substantially arbitrage-free value.

14. The method of claim 13 wherein the substantially arbitrage-free value comprises a substantially arbitrage-free value that is substantially independent of at least one of an option holder's personal risk and personal wealth.

15. A digital memory having stored therein instructions that correspond, at least in part, to:
at least a first and second option termination event which first and second option termination event can each impact in different ways, at least in part, a window of exerciseability as corresponds to an option;
an option model that is a function, at least in part, of a risk assessment for the first and second option termination event.

16. The digital memory of claim 15 wherein the first and second option termination event comprise first and second stock option termination events.

17. The digital memory of claim 16 wherein the first and second stock option termination events correspond to employment termination events.

18. The digital memory of claim 17 wherein at least one of the employment termination events comprises at least one of:
voluntary severance;
severance for cause;
death;
corporate bankruptcy.

19. The digital memory of claim 15 wherein the option model further comprises a multi-termination binomial model.

20. The digital memory of claim 15 wherein the option model further comprises a multi-termination partial differential equation-based process.
